(19) United States
(12) Patent Application Publication
(10) Pub. No.: US 2007/0192238 A1
(43) Pub. Date: Aug. 16, 2007

(54) Method and system for corporate overdraft

(76) Inventors: Ammar Ahmad Shata, Jeddah (SA); Fahad Siraj Malaikah, Jeddah (SA)

Correspondence Address: MORRISS OBRYANT COMPAGNI, P.C., 734 EAST 200 SOUTH, SALT LAKE CITY, UT, 84102, US

(21) Appl. No.: 11/434,288

(22) Filed: May 15, 2006

Related U.S. Application Data
(60) Provisional application No. 60/772,803, filed on Feb. 13, 2006.

(51) Int. Cl. G06Q 40/00

(52) U.S. Cl. 705/38

(57) ABSTRACT

Methods and systems for providing a Shari'a compliant overdraft facility. A client offers to sell an asset to an overdraft provider, such as a financial institution. If the asset meets credit eligibility criteria, the provider may set up an overdraft account for conducting trade of the asset or part of the asset. The client can access the account by withdrawing funds therefrom. If the client successfully withdraws funds from the account, this indicates that the provider has agreed to purchase asset units equivalent to the funds withdrawn. The provider then leases the asset units back to the client at a pre-determined lease markup, which may be calculated and settled on a daily basis, under a Shari'a-approved Ijara wa Iqtina' contract. If the client successfully deposits funds in the overdraft account, this indicates that the provider has sold back the asset units to the client on a pro-rata basis.

### CROSS-REFERENCE TO RELATED APPLICATION

This application claims the benefit of U.S. Provisional Application No. 60/772,803, filed Feb. 13, 2006, which is incorporated herein by reference in its entirety.

### TECHNICAL FIELD

This invention relates generally to banking processes and systems for providing short-term credit facilities, and more specifically relates to a method and system for short-term corporate overdraft that complies with Islamic jurisprudence and religious doctrine.

### BACKGROUND

Under Islamic religious law, known as “Shari'a”, the lending of money is viewed as a charitable, rather than profit-seeking act, and the payment or receipt of interest on loans of money is generally prohibited. Thus, Muslims may face significant obstacles in their financial transactions, as they attempt to comply with Shari'a.

There have been attempts to provide Shari'a compliant financial products. For example, U.S. Published Patent Application US 2004/02336654, the disclosure of which is incorporated by reference herein, is directed to a financial investment product that may comply with Shari'a. Similarly, U.S. Pat. No. 6,052,674 is directed to an electronic invoicing system for collecting payments and assessing late payment penalties in a Shari'a compliant manner. Further, with respect to the residential real estate market, there have been a number of financing arrangements used or proposed which meet Shari'a requirements, yet concurrently enable Islamic consumers to obtain the funds necessary to acquire a home.

Islamic law recognizes that co-owners of property may share the fruits of their Co-Ownership in a mutually agreeable manner. The arrangement between co-owners of property can be viewed as a business arrangement between the parties. Islamic law also recognizes that businesses are based on profit, and, thus, businesses need profit to survive. Traditional Shari'a compliant home-financing arrangements rely on these principles to provide interest-free loans. For example, in a “lease to own” arrangement (or “Ijara”), there are two interdependent contracts: one to lease the property and the second to buy the property. The consumer is obligated to acquire ownership of the home in which he or she is residing under a purchase contract and is also obligated to pay rent under a lease contract. The consumer generally pays a monthly amount that goes towards the purchase price of the home, in addition to paying rent.

Similarly, in an “installment sale contract” (or “Murabaha”), an installment sale similar to a traditional purchase money mortgage is used. Payments under the installment sale have amortization of debt or return of capital, as well as a profit component. A consumer selects the real estate property, which is purchased by the financier, who then resells it to the consumer for the initial sales price plus an agreed upon profit. Title to the property generally is retained by the financier. A third form of interest-free Islamic financing is the “decreasing partnership.” This is also a “rent-to-own” concept. Either a partnership agreement is used and ownership is in the partnership, or, the lender retains legal title and the homebuyer has a savings investment in the institution which is transferred to the institution for the homebuyer to become a co-owning partner with the institution. The partnership leases the residence to the homebuyer at an agreed monthly rent and the homebuyer purchases more equity in the home from the partnership over time.

Since such transactions are too costly and complex to be broadly applied to the home financing market, attempts to provide alternative structures that satisfy Shari'a, while making the financial instruments saleable (similar to the resale of mortgages by the initial lender) or to ease record-keeping have been developed. Examples of such structures include those disclosed in U.S. Published Patent Applications US 2003/0233324, US 2004/0205020, US 2004/0177029, and US 2005/0114151, the disclosures of each of which are incorporated by reference herein. Thus, while there have been significant developments in medium-term and long-term Islamic financing instruments during the past 20 years related to residential real estate, short-term financing solutions and appropriate corporate financing solutions are yet to be created. It is believed that prior to the overdraft system of the present invention that no financial institution in Saudi Arabia offered an Islamic jurisprudence compliant corporate overdraft product. Rather, conventional interest-based facilities dominated the industry.

Thus, there is a need in the art for a method and system for corporate overdraft that complies with Islamic jurisprudence and religious principles as well as modern banking internal policies and procedures. It is desirable that such an Islamic corporate overdraft facility allows for short-term financing that can be extended on a daily basis. Thus, there exists a need in the art for a method and system for short-term corporate lending including overdraft lending that complies with Islamic jurisprudence and is not disclosed in the prior art.

### SUMMARY

In one illustrative embodiment a Shari'a compliant overdraft facility may be provided in accordance with the present invention along the following lines. A client that requires an overdraft facility offers to sell an asset to an overdraft provider, such as a financial institution. If the asset meets the provider's credit eligibility criteria, then the provider sets up an overdraft account, such as a bank account, for conducting trade of the asset or part of the asset. The client can access the account by withdrawing funds therefrom. If the client successfully withdraws funds from the account, this indicates that the provider has agreed to purchase asset units which are equivalent to the funds withdrawn. The provider then leases the asset units back to the client at a pre-determined lease markup, which may be calculated and settled on a daily basis, under a Shari'a-approved Ijara wa Iqtina' contract. If the client successfully deposits funds in the overdraft account, this indicates that the provider has sold back the asset units to the client on a pro-rata basis.

Additional features and advantages of the invention will be apparent from the detailed description which follows, taken in conjunction with the accompanying drawings, which together illustrate, by way of example, features of embodiments of the present invention.

### DESCRIPTION OF THE DRAWINGS

The following drawings illustrate exemplary embodiments for carrying out the invention. Like reference numerals refer to like parts in different views or embodiments of the present invention in the drawings.

FIG. 1 is a flow chart of a first embodiment of a method for providing a Shari'a compliant overdraft in accordance with the principles of the present invention.

FIG. 2 is a flow chart of a first embodiment of a method for activating a Shari'a compliant overdraft activation in accordance with the principles of the present invention.

### DETAILED DESCRIPTION

The following definitions are used throughout the detailed description of the various embodiments of the present invention. The term “client” refers to an entity seeking an embodiment of an Islamic corporate overdraft according to the present invention. The typical client will be a corporate entity in need of an overdraft for business purposes. However, it will be appreciated that, in some embodiments, non-corporate entities or individuals may be allowed to access a Shari'a compliant overdraft in accordance with the present invention.

The term “provider” refers to a lender that intends to deliver an embodiment of an Islamic corporate overdraft according to the present invention. A provider may be a financial institution, such as a bank, (such as an Islamic bank), a credit union, brokerage, or other lender.

The term “agreement” refers to the complete set of official and legally-binding, documents between a provider and a client, which defines the relationship in terms of the overdraft facility. In some embodiments, the agreement may consist of a single legally binding instrument, which covers all aspects of the overdraft relationship. In other embodiments, the agreement may comprise a set of related documents, such as separate leases and deeds for recording with the appropriate legal authority in addition to a general relationship governing contract.

The term “asset” refers to the complete set of revenue-generating assets (or other means of benefits) owned by a client and available for full or partial sale to a bank in connection with an overdraft in accordance with the present invention. The term “asset unit” refers to a fractional share of a revenue-generating asset. The terms “facility” and “Islamic overdraft facility” both refer to embodiments of the present invention which are directed to a short term corporate lending mechanism that complies with Islamic jurisprudence and religious principles as well as modern banking internal policies and procedures.

The term “Fatwa” is an Arabic word meaning religious edict. The term “Ijara wa Iqtina'” is an Arabic phrase meaning lease-purchase or lease with buy-back. The term “lease-purchase” refers to a lease in which the lessee acquires the leased asset from the lessor at maturity. The term “markup/rent” refers to profit realized by a lessor on a lease-purchase contract. The acronym “PD” is short for probability of default. The term “Shari'a” refers to Islamic doctrine. The term “overdraft account” refers to an account (which may be a bank account established at the provider) and associated agreements between a client and a provider for conducting trade of asset units.

SIBOR stands for Singapore Interbank Offered Rate and is a daily reference rate based on the interest rates that banks offer to lend unsecured funds to other banks in the Singapore wholesale (or “interbank”) money market. It is similar to the widely used LIBOR (London Interbank Offered Rate), and Euribor (Euro Interbank Offered Rate). According to embodiments of the present invention, the “overdraft account” may only be used for asset units trading. The currency used in the examples below is the Saudi Riyal (SAR). However, it will be obvious to those skilled in the art that the invention is not limited to any particular currency.

In order for a provider to institute an Islamic jurisprudence compliant overdraft solution in accordance with the present invention, initial Shari'a approval may be obtained. Thus, an embodiment of a method for obtaining Shari'a approvals according to the present invention is disclosed. The method may include providing initial Shari'a approval for the process structure from a reputable Shari'a process endorser. This step may be performed by selected financial advisors, the provider desiring to implement the inventive credit facility or by anyone else qualified to do so. The method may further include obtaining an approval from a provider's internal Shari'a committee. This step may be performed by selected financial advisors assisting the provider prior to its internal Shari'a committee meeting in order to present the proposed solution and seek initial approval, if desired. Such a method may further include developing legal documents and/or contracts for implementing the inventive credit facility. This step may also be performed by selected financial advisors assisting the provider in coordinating with its internal or external legal department during development of the legal documents and/or contracts. The method may further include a Shari'a committee reviewing the legal documents and/or contracts and obtaining approval of the legal documents and/or contracts. The method may further include finalizing legal documents/contracts by making any amendments suggested by the Shari'a committee. The method may further include obtaining final approval on the legal documents and/or contracts. The method of the present invention thus extends the application of the Ijara wa Iqtina' contract to the application of flexible duration short-term financing.

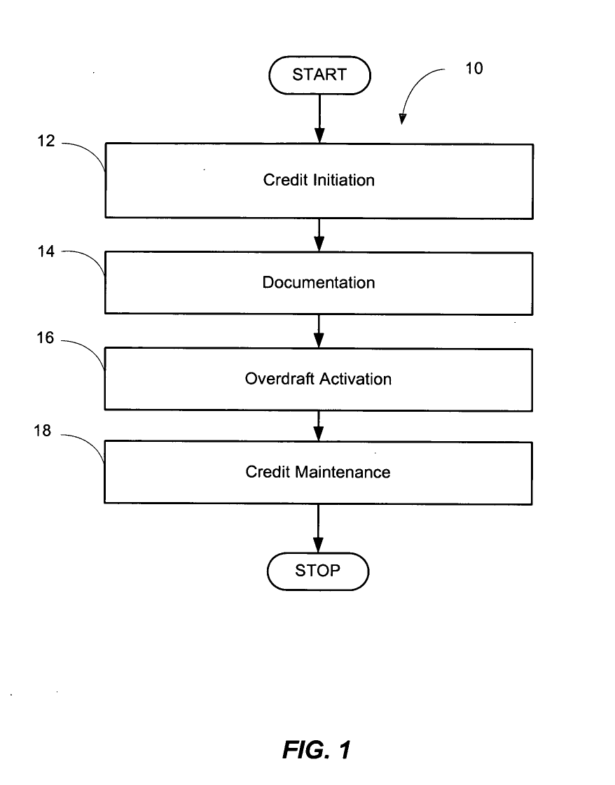

Referring now to FIG. 1, there is illustrated a process, generally indicated at 10 in accordance with the principles of the present invention, that includes four stages which may be applied to provide the inventive overdraft facilities to clients according to embodiments of the present invention. The stages are: Credit Initiation 12, Documentation 14, Overdraft Activation 16 and Credit Maintenance 18. An important feature of the inventive process is that the conversion from conventional to Islamic model minimizes the disruption to a financial institution's existing infrastructure without compromising the spirit of the Fatwa. Thus, a balance has been achieved by introducing a product that is efficient from a banking perspective and pure from an Islamic jurisprudence perspective. An embodiment of a business process used for an Islamic overdraft according to the present invention bears resemblance to conventional overdraft in terms of accounting and information technology (IT). However, there are significant differences in set-up (fund withdrawal) and termination (repayment of principle) as there is a revenue-generating asset which is bought by the provider and leased to the client based on a cost of funds plus a markup. The client eventually repurchases the asset back from the provider.

In a preliminary stage, Credit Initiation 12, the client initiates the credit facility by proposing the full or partial sale of an asset to the provider which has been selected to offer the credit facility. It will be appreciated that any asset acceptable to a provider may be used, but that typically such assets will be revenue generating assets, including commercial real estate (such as warehouses, office buildings, etc.), machinery (such as manufacturing, production or business machinery), or other revenue generating assets (which may include fleet assets, such as planes, vehicles or other equipment). The asset used must meet all the conditions of Ijara.

The provider or its representatives will evaluate the proposed asset in terms of current and future value along with the revenues generated from it. The evaluation criteria are within the scope of knowledge of those or ordinary skill in the art and may also be entirely at the discretion of the provider. Asset valuation will typically involve appraisal in accordance with recognized standards for the type of proposed asset. As asset valuation is a costly process and has a risk of revealing the asset ineligible for utilization by the provider, the provider may request the client to pay an upfront asset valuation fee to conduct the necessary due diligence. Appropriate and suitable facility limits may be set in accordance with the asset that is to be purchased from the client. This is similar to the conventional maximum overdraft limit set for individual clients based upon each client's risk assessment.

Furthermore, the provider may determine a lease markup that incorporates all aspects of credit risk including, but not limited to such factors as: cost of funds, fees, profit, expected losses (including PD), adjustments +/−, concentration (+) or diversification (−) and other factors that may influence credit-worthiness of the client. The lease markup may be pre-agreed between the provider and the client and clearly and explicitly stated in the agreement between the parties. The lease markup, according to Shari'a, must remain static and cannot be changed unless both lessor (provider) and lessee (client) agree in a revision or addendum to the agreement. Alternatively, the lease markup may be made variable through the definition of cap and floor according to another embodiment of the present invention.

For the sake of comparison with conventional financing, the lease markup may be correlated with an interest rate. For example and not by way of limitation, the lease markup might be based on a daily reference rate, such as SIBOR. For example, the lease markup could be (8%+4%)=12%, where 8% is a Singapore Inter Bank Offered Rate (SIBOR) and 4% is profit. The outcome of the credit initiation stage may thus yield two results: (1) a maximum overdraft limit to the client and (2) a lease markup for the client. The provider's asset valuation may indicate the following: the asset's current value, annual revenue generated by asset, annual lease markup by the provider on the purchased asset and the maximum number of asset units that the provider may purchase from the client. These outcomes may be stipulated in the lease-purchase agreement between the provider and the client. The legal aspects of the agreement are further discussed below.

As part of Documentation 14 of the asset, the provider may take the necessary measures to reduce risks of asset ownership according to the present invention. Risk reduction may be important, whether the provider may have full ownership or joint/partial ownership of the asset. Risk reduction measures may include, but are not limited to, the following: transfer of deed(s) and/or title(s), obtaining waiver(s) or indemnification to protect the asset against ownership disputes, claims and other uncertainties and insuring the asset against loss, damage, theft and other disasters. The policies and procedures for asset documentation and disbursement may resemble those which are used for the reduction of risk with fixed-asset collateral in traditional financial undertakings. Documentation and disbursement procedures associated with the reduction of risk may be accomplished according to any suitable procedures known to those skilled in the art and may be entirely at the discretion of the provider.

Once Credit Initiation 12 is complete and any Documentation 14 required by the provider is complete, Overdraft Activation 16 may take place. In Overdraft Activation 16, the asset may be “divided” into equal asset units which may be purchased by, and leased from, the provider. Such division is an accounting measure. For example, if an asset is a 5000 square meter building valued at SAR 1,000,000, it could be divided into 5000 asset units. Each asset unit would be valued at SAR 200. Taking the example further, if the provider has determined that it will provide a maximum overdraft facility that corresponds to 2000 out of the 5000 total asset units, this would make the provider's maximum available purchase amount equivalent to SAR 400,000. The offering of such a facility will be discussed in more detail further herein. It should also be noted that some of the acts detailed herein may be combined to reduce the overall number of steps in the overdraft activation stage. However, for a better understanding of the logic behind the inventive credit facility, these steps have been segregated for clear explanation.

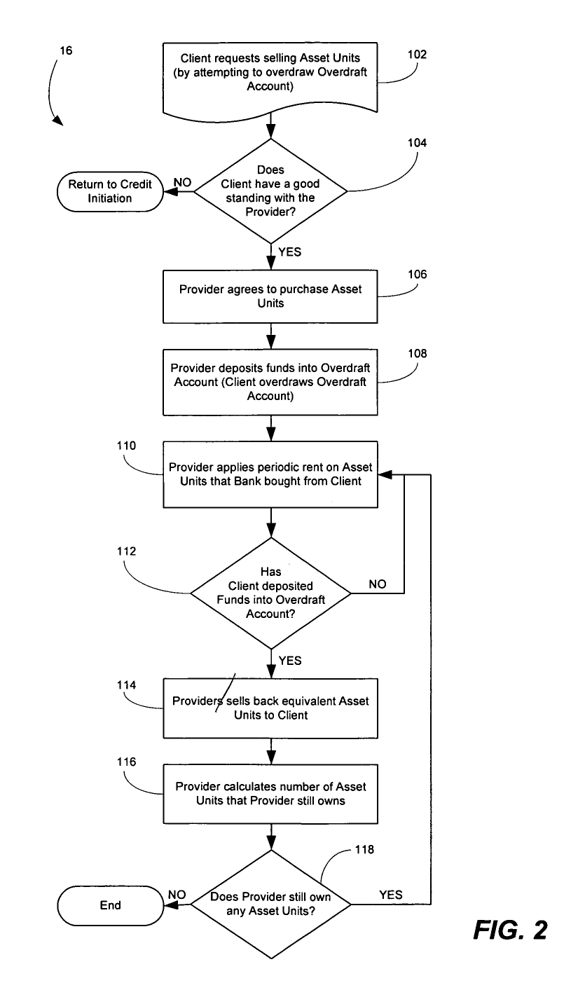

As illustrated in FIG. 2, the Client may activate the overdraft by offering or requesting 102 to sell a certain number of asset units to the provider. This may be performed by making a fund withdrawal request from a pre-agreed overdraft account number at the provider. The withdrawal request is equivalent to the sum of asset units that the client wishes to sell. The fund withdrawal request may be automatically made by the Client through a traditional banking method. For example, if the client has a business account (such as a business checking or other corporate account) with the provider, incurring a negative balance in that account may automatically trigger a request to sell a certain number of asset units to the provider. In such an example, the asset units may be those asset units sufficient to cover the shortfall in the other account. Alternatively, a request may be made by charging an amount to the pre-agreed specified account, as by issuing a draft drawn from the pre-agreed account.

At the time of the request 102, the provider may make a determination 104 as to whether the Client is currently in good standing. If not, the provider may require the client to return to Credit Initiation 12. Thus, the provider may be able to accept or decline the client's offer to sell asset units through activity in the overdraft account.

If the provider agrees, then it will purchase the requested number of asset units, as depicted at 106, and the withdrawal of funds by the client will be successful. In one illustrative example, if the client needs SAR 160,000, then the client may do so by selling 800 asset units (with a value of SAR 200 per unit) by requesting to withdraw SAR 160,000 from the pre-agreed overdraft account.

While the unit price is fixed and cannot be altered by either party, the quantity of traded asset units may be agreed between provider and client at any given point in time. The rent fee may also be fixed at either point in time, or may be adjusted in response to current market conditions. The mechanism by which the provider accepts purchase of asset units is through payment through the overdraft account, which constitutes a transfer of funds to the client.

In this illustrative example, assuming that the provider has no objection towards purchasing 800 asset units from the client (at a unit value of SAR 200 as per the agreement), then the provider's depositing of cash into the overdraft account, as depicted at 108, in response to the client's request is, in fact, a purchase/trade of an equivalent quantity of asset units. Once the client requests selling asset units, by withdrawing funds from the account, the provider immediately acquires those asset units as per the agreement, as soon as the funds are transferred to the client.

It should also be noted that as the present invention may provide efficient mechanisms for activating the overdraft facility, this may reduce activity-based costs, improve profitability margins for the provider and provide greater client satisfaction. Therefore, a “document-less trade”, as described further herein may achieve such an efficient transaction flow. It will be appreciated that although described as “document-less,” that the provider may provide written trade confirmations following transaction completion.

Once a provider purchases asset units, it leases those asset units to the client. The client may then lease-purchase those asset units at a pre-agreed annual lease markup, which may correspond to the annual revenue generated by the asset. For example, if the asset unit has a rent fee of SAR 14 per annum, then 800 asset units will have an annual leasing markup of SAR 11,200. This approach should not conflict with Shari'a given that Ijara wa Iqtina' conditions are fully met.

The provider may apply rent 110 on outstanding asset units, on a daily, weekly monthly or other basis. To provide the flexibility required for a short-term lending, which is likely to be days rather than weeks or months, the lease-purchase fees will typically be applied on a daily basis rather than an annual basis. That is, each asset unit will have a daily lease-purchase markup while being utilized by the client and under the ownership of the provider. For example, if 800 asset units require an annual markup of SAR 11,200, then those assets units will have a daily lease-purchase markup of SAR 31.11 (assuming that a single year is comprised of 360 days, i.e., 11,200/360=31.11).

Eventually, the client may re-purchase asset units from the provider. That is, the client is entitled to purchase all or part of asset units sold to the provider during any point in time as set forth in the agreement. For efficient operation, the repurchase may be conducted through the specified account. In one illustrative example, the client may intend to purchase 50% of the asset units that are owned by the provider. The client may deposit an amount of money equivalent to the number of asset units that will be bought back from the provider into the overdraft account. For example, in order for the client to buy-back 400 asset units (priced at SAR 200 per unit), the client would deposit SAR 80,000 in the overdraft account. If the provider accepts the client's deposit of funds in the overdraft account, this would indicate the acceptance of the provider in selling an equivalent number of asset units in accordance with the agreed unit value. In this particular example, acceptance of an SAR 80,000 deposit by the provider would conclude the sale of 400 asset units to the client. The remaining 400 asset units (the other 50%) would remain in the possession of the provider. The lease-purchase markup on the remaining (400) asset units would be recalculated.

Purchase of the asset units by the client from the provider may occur at only agreed upon time, or may occur at any point, as may be provided in the agreement. Where repurchase may occur on a daily basis, the provider will need to check on a daily basis as to whether the client has deposited 112 funds in the overdraft account that corresponds to a buy-back intent/transaction.

In accordance with the agreement, the number of outstanding asset units may be reviewed and adjusted following each business cycle. If the Client has deposited 112 funds into the Overdraft account, the provider sells 114 back equivalent Asset Units to the Client. The provider then calculates 116 the number of Asset units that it still owns. If it is determined 118 that the provider does not own any additional Asset Units, the transaction between the bank and Client may be considered terminated.

Referring again to FIG. 1, during Credit Maintenance 18, the provider may reevaluate the client's assets on a periodic basis. This can be performed at any suitable cycle, for example and not by way of limitation, once between 12 and 36 months after signing the agreement, or on an annual basis. Asset valuation policy and procedures are within the knowledge of one skilled in the art and may further be left to the discretion of the provider. By periodically revaluing the asset, the provider may be best able to adjust the conditions to minimize its risk and the client may benefit from having a current value of the asset used.

Importantly, accounting entries of the present invention may be compliant with existing banking information technology (IT) systems. Thus, while the embodiments of the credit facility disclosed herein utilize Shari'a-compliant contracts and methodology, the majority of core banking IT systems do not support such a solution. To overcome this obstacle, this present invention is designed to function from an accounting and IT perspective in a manner similar to conventional banking, especially to that of conventional overdrafts.

To elaborate further, the contractual agreements between the bank (lessor) and the client (lessee) are based upon Ijara wa Iqtina', however, the definitions of operational and financial lease in the International Accounting Standards (IAS 17) do not comply with Shari'a. Hence, the accounting treatment proposed by IAS 17 cannot be applied for this product. An important feature of the inventive credit facility is to apply the conventional overdraft's accounting treatment for the inventive credit facility in an innovative manner while maintaining functionality with existing core banking IT systems. In connection with the Figures, the present invention includes methods of customizing generic accounting entries in financial accounting software and systems in accordance with a provider's chart of accounts. Accounting entries may occur in the provider's records and in the units of currency of choice, e.g., SAR, USD or any other unit of currency.

During Credit Initiation 12, the provider may request clients to pay an upfront fee for asset valuation. This asset valuation fee would cover the costs associated with the clients and/or assets that do not meet the provider's eligibility criteria. The accounting entries for such fees may be developed according to the provider's chart of accounts. An example of a SAR 500 fee for asset valuation may be as shown in TABLE 1, below.

TABLE 1

| Dr | Cr | Statement | Description | Amount |
|---|---|---|---|---|
| xxx | | Cash | Upfront fee settled by the client | 500.00 |
| xxx | | Revenues | Asset valuation fees | 500.00 |

While no accounting entries are required for the Documentation Stage 14, the provider may create an overdraft account for each asset that the client wishes to trade with the provider. Note that the client may have one or more assets that are utilized for short-term financing. Each asset may have a separate contract and a dedicated overdraft account. Of course, it will be appreciated that multiple assets may be pooled and utilize a single contract and a single dedicated overdraft account, where acceptable to the provider and the client.

In Stage C, Overdraft Activation 16, the accounting entries for the Overdraft Activation 16 stage are described below. TABLE 2 illustrates some example book entries for the provider in paying for asset units through deposit in an overdraft account, during the Overdraft Activation 16 stage.

TABLE 2

| Dr | Cr | Statement | Description | Amount |
|---|---|---|---|---|
| xxx | | Current | The provider realizes full or | Asset Units x |
| | | Assets | joint ownership of the asset. | Unit price |
| | | | Sub-account may be leased | |
| | | | properties for trade | |
| | xxx | Cash | Funds transferred from the | Asset Units x |
| | | | provider's treasury to the | Unit price |
| | | | overdraft account | |

As described previously herein, the provider may apply periodic lease-purchase markup on outstanding asset units, which may be on a daily basis. Given that the client is leasing the asset from the provider, the periodic markup may be required on all outstanding assets which in the provider's possession (and thus are being leased to the client). TABLE 3 illustrates some example book entries for the provider during this revenue recognition.

TABLE 3

| Dr | Cr | Statement | Description | Amount |
|---|---|---|---|---|
| xxx | | a/c | The client's overdraft account | Outstanding |
| | | receivable | is provided with funds | Asset Units x |
| | | | | Markup/360 |
| | xxx | Revenue | Revenue generated through | Outstanding |
| | | from | the lease-purchase contract | Asset Units x |
| | | financing | | Markup/360 |
| | | activities | | |

It is noted that it may be necessary to calculate the revenue during the ‘closed’ phase of the business cycle. The closed phase of the business cycle is that which follows cut-off and precedes cutover.

Since it may be possible that the client may decide to buy-back a number of unit assets at any point in time, it may be necessary for the provider to check on a daily basis whether the client has deposited funds in the overdraft account that would suffice to repurchase assets units. Although different procedures may be used for the accounting of such buyback, in one illustrative example the following sequence may be used for settlement of rent and Client buy-back of asset units.

As part of the process, the provider will need to settle the outstanding Rent. When the Client deposits funds for repurchase of asset units, the provider may deduct the amount necessary to settle any outstanding Rent from these funds. TABLE 4 depicts some example book entries a provider may use for tracking such transactions.

TABLE 4

| Dr | Cr | Statement | Description | Amount |
|---|---|---|---|---|
| xxx | | Cash | The client deposits funds into | Outstanding |
| | | | the overdraft account, from | Rent |
| | | | which rent is subtracted | |
| | xxx | a/c | The bank eliminates the client's | Outstanding |
| | | receivable | rent liability up to previous | Rent |
| | | | business cycle | |

At times, the provider may also need, or desire, to sell-back Asset Units. In the event that the client deposits funds, the provider's asset ownership will change in accordance with the following formula:
Outstanding Asset Units=Previous Asset Units−(Funds Deposited/Unit Price)

where “Previous Asset Units” are asset units held by the provider as of the previous relevant business cycle and “Available Funds” equals funds deposited by the client during the previous business cycle LESS the amount deducted to settle the client's outstanding rent. The result may be rounded down to the nearest number of asset units. Any remaining fraction of an asset unit may be used to settle markup during the next business cycle. The provider will cease to own asset units once the outstanding asset units becomes zero. TABLE 5 below shows some illustrative accounting entries for this scenario.

TABLE 5

| Dr | Cr | Statement | Description | Amount |
|---|---|---|---|---|
| xxx | | Cash | Funds transferred back to | Funds deposited |
| | | | the provider's treasury | during the previous |
| | | | | business cycle |
| | xxx | Current | The provider removes | Funds deposited |
| | | | asset units from its | during the previous |
| | | | balance sheet | business cycle |

During Credit Maintenance 18, there will typically not be accounting entries. However, if there is an updated valuation of the asset, the agreement between the client and the provider should be updated accordingly.

The provider should also assess risks and apply mitigation strategies where necessary. That is, risks associated with the inventive credit facility as described below need to be viewed vis-á-vis risks in conventional overdraft. Whereas conventional overdraft is far riskier because it is unsecured, the Islamic Corporate Overdraft of the present invention is secured as an asset backed transaction. In the event of a default, the provider may reserve the right to continually earn its rent from the transferred asset units for as long as it takes to liquidate the advanced monies. To that end, this product should also have a cheaper cost of funds compared to a conventional overdraft. Various key risks and related mitigations are examined in the following discussion.

Credit risk may be covered by the availability of security and the ability to collect rent from the asset units purchased and leased back. Such risk may be further mitigated by: (1) a strict customer eligibility criteria, in addition to asset eligibility criteria, (2) taking conservative and adequate provisions against risks of default, payment and interest rates, (3) using a state of the art management information system (MIS) and (4) developing efficient legal and collection teams and procedures.

Any defaults may be followed on/worked out with the Customer. In such cases, the provider may resort to progressive measures to ensure client compliance. Those include, but are not limited to any or all of the following: (1) suspension of the client's other credit facilities, (2) initiation of legal proceedings against the Client and (3) the liquidation of assets (collateral) which are partially or fully owned by or in the possession of the provider (like asset units, or current account or deposit balances). To a large extent, an Islamic overdraft as described herein may have less risk than a conventional overdraft given the availability of an asset (security) and that the payment of rent (markup) is a contractual, non-disputable, obligation. Other conventional measures to mitigate risk include: client eligibility criteria, asset eligibility criteria, facility cushion (margin below asset valuation), conservative provisions, efficient collection and dispute settlement.

With respect to Shari'a and legal risk, any risk implies that the product may not be Shari'a acceptable. By obtaining an initial approval from a Shari'a endorser, a significant aspect of the risk in developing the inventive overdraft product and methods described herein may be mitigated. Also, careful scrutiny by internal and/or external legal consultants may be required to ensure the proposed legal documents will: (1) satisfy the demands of the provider's Shari'a committee in order to obtain final approval and (2) fully address issues that may affect the provider's exposure. Those issues may include, but not limited to, the following: credit terms, collection, the provider's liabilities, client settlement delay or default and dispute settlement. Select financial advisors may be ideally suited for preparation of the legal contracts necessary for governing the relationship between the provider and the client. However, the provider must ensure that these deliverables meet or exceed its risk policy.

Operational risks may include improper selection or approval of an asset resulting in liability against the provider. Mitigation of operational risks may be achieved through insurance against such risks and other waivers.

There may also be a risk associated with cap and floor. That is, a provider may carry a risk of going off market in either direction of this rate structure and thereby incurring losses. This can be mitigated by a cautious approach to determining the cap and floor with the provider's treasury prior to finalizing such parameters with the client. In any event, the cap and floor may be set for a limited period (such as a one year period) and should not represent a high risk during that period as it may be set short enough that interest rates for that period can be determined with adequate accuracy.

The legal contracts and other documents that govern the relationship between the provider and the client may be prepared by selected financial advisors and provided separately. Such contracts should undergo rigorous reviews by the concerned departments of the provider. Such concerned departments or parties may include, but are not limited to the provider's: internal legal department, external legal advisors, risk management department, Shari'a Committee and corporate banking department.

While the foregoing advantages of the present invention are manifested in the illustrated embodiments of the invention, a variety of changes can be made to the configuration, design and construction of the invention to achieve those advantages. Hence, reference herein to specific details of the methods and specific applications of the methods discussed with reference to the embodiments of the present invention are by way of example only and not by way of limitation.

What is claimed is:

1. A method of providing short-term financing that is compliant with Islamic jurisprudence, the method comprising:
establishing an account related to an asset owned by a client;
purchasing at least a portion of the asset by allowing the client to withdraw funds from the account; and
leasing the purchased at least a portion of the asset to the client.

2. The method according to claim 1, wherein establishing an account related to an asset owned by the client comprises establishing an overdraft account at a financial institution.

3. The method according to claim 1, wherein establishing an account related to an asset owned by the client comprises evaluating the asset by appraisal.

4. The method according to claim 3, wherein evaluating the asset by appraisal comprises evaluating the revenue generating capability of the asset.

5. The method according to claim 3, further comprising charging the client an asset evaluation fee for evaluation the asset by appraisal.

6. The method according to claim 1, wherein establishing an account related to an asset owned by the client comprises apportioning at least part of the value of the asset into separate asset units of fixed value, such that the total of the sum of the value of the asset units is equal to the at least part of the value of the asset.

7. The method according to claim 6, wherein purchasing at least a portion of the asset by allowing the client to withdraw funds from the account comprises purchasing a number of asset units of equal value to the withdrawn funds.

8. The method according to claim 7, wherein leasing the purchased at least a portion of the asset to the client comprises applying a periodic rental rate to the purchased asset units and charging the client the periodic rental rate for each purchased asset unit during a time period associated with the periodic rental rate.

9. The method according to claim 8, wherein the time period associated with the periodic rental rate is a daily, weekly or monthly time period.

10. The method according to claim 8, applying a periodic rental rate to the purchased asset units comprises applying a periodic rental rate based on an interbank money marker reference rate.

11. The method according to claim 8, applying a periodic rental rate to the purchased asset units comprises applying a periodic rental rate based on the revenue generating properties of the asset.

12. The method according to claim 1, wherein purchasing at least a portion of the asset by allowing the client to withdraw funds from the account comprises receiving a withdrawal request from the client and depositing funds equal to the request into the account for withdrawal by the client.

13. The method according to claim 12, wherein receiving a withdrawal request from the client comprises having the client receiving a notification that a second account associated with the client has a negative balance.

14. The method according to claim 1, further comprising selling at least part of the purchased at least a portion of the asset by allowing the client to deposit funds into the account.

15. The method according to claim 14, further comprising recalculating a rental rate charged to the client based on the change in the amount of the purchased at least a portion of the asset.

16. The method according to claim 1, further comprising utilizing existing financial institution IT systems to track transactions in the account associated with the asset owned by the client.

17. A process for providing a Shari'a compliant corporate overdraft, the process comprising:
evaluating a revenue-generating asset as collateral for a corporate overdraft to determine asset value and client credit worthiness;
apportioning the revenue-generating asset into a number asset units each having a unit value based on the total asset value;
transferring funds into an overdraft account and transferring ownership of an equivalent number of asset units to a lessor upon honoring a request to withdraw funds from the overdraft account;
charging rent against the overdraft account based on the equivalent number of asset units on a short term basis; and
returning ownership of asset units in exchange for repayment into the overdraft account of a unit value plus the rent.

18. The process of claim 17, wherein evaluating a revenue-generating asset as collateral for a corporate overdraft to determine asset value and client credit worthiness comprises appraising a revenue generating asset selected from the group consisting of commercial real estate, manufacturing machinery, and transportation machinery.

19. The process of claim 17, wherein transferring funds into an overdraft account and transferring ownership of an equivalent number of asset units to a lessor upon honoring a request to withdraw funds from the overdraft account comprises transferring funds upon receiving a request to withdraw funds from the overdraft account.

20. The process of claim 19, wherein receiving a request to withdraw funds from the overdraft account comprises receiving a notification of a negative balance in a corporate account.

21. The process of claim 17, wherein charging rent against the overdraft account based on the equivalent number of asset units on a short term basis comprises applying a periodic rental rate to the equivalent number of asset units to calculate rent on a periodic basis.

22. The process of claim 21, wherein applying a periodic rental rate to the equivalent number of asset units to calculate rent on a periodic basis comprises applying a periodic rental rate based on an interbank money market reference rate.

23. The process of claim 21, wherein applying a periodic rental rate to the equivalent number of asset units to calculate rent on a periodic basis comprises applying a periodic rental rate to the equivalent number of asset units to calculate rent on daily basis.

24. A system for providing Shari'a compliant short-term financing in a financial institution, comprising:
means for tracking an overdraft account related to an asset owned by a client;
means for tracking the purchase of at least a portion of the asset by allowing the client to withdraw funds from the account; and
means for managing the lease of the purchased at least a portion of the asset to the client.

25. The system of claim 24, wherein tracking an overdraft account comprises inputting an evaluation of the asset owned by the client into financial accounting software running on a computer.

26. The system of claim 25, wherein inputting an evaluation of the asset owned by the client into financial accounting software running on a computer comprises inputting an evaluation of the asset which appraises the revenue generating capability of the asset.

27. The system of claim 25, further comprising means for charging the client an asset evaluation fee for the evaluation of the asset.

28. The system of claim 24, wherein means for tracking the purchase of at least a portion of the asset by allowing the client to withdraw funds from the account comprises means for apportioning at least part of the value of the asset into separate asset units of fixed value and tracking the withdrawal funds from the account to calculate the number of asset units purchased which are of equal value to the withdrawn funds.

29. The system of claim 24, wherein means for managing the lease of the purchased at least a portion of the asset to the client comprises means for calculating rent by applying a periodic rental rate to the purchased asset units and means for charging the client the periodic rental rate for each purchased asset unit during a time period associated with the periodic rental rate.

30. The system of claim 29, wherein the time period associated with the periodic rental rate is a daily, weekly or monthly time period.

31. The system of claim 29, applying a periodic rental rate to the purchased asset units comprises applying a periodic rental rate based on an interbank money marker reference rate.

32. The system of claim 29, wherein tracking the purchase of at least a portion of the asset by allowing the client to withdraw funds from the account comprises receiving a notification that a second account associated with the client has a negative balance.

33. The system of claim 24, further comprising means for tracking the repurchase of at least part of the purchased at least a portion of the asset by the client.

34. The system of claim 33, wherein tracking the repurchase of at least part of the purchased at least a portion of the asset by the client comprises tracking the deposit of funds into the overdraft account.

35. The system of claim 34, wherein tracking the repurchase of at least part of the purchased at least a portion of the asset by the client further comprises recalculating a rental rate charged to the client based on the change in the amount of the purchased at least a portion of the asset.

36. The system of claim 24, wherein the means for tracking an overdraft account related to an asset owned by a client, the means for tracking the purchase of at least a portion of the asset by allowing the client to withdraw funds from the account, and the means for managing the lease of the purchased at least a portion of the asset to the client, each comprise financial record-keeping software running on an existing financial institution IT system.
